(19) United States
(12) Patent Application Publication
(10) Pub. No.: US 2008/0255297 A1
(43) Pub. Date: Oct. 16, 2008

(54) INK-JET INK

(75) Inventors: Setsuo ITAMI, Chiba (JP); Tomohiro ETO, Chiba (JP); Hiroyuki SATOU, Chiba (JP)

Correspondence Address: J C PATENTS, INC., 4 VENTURE, SUITE 250, IRVINE, CA, 92618, US

(73) Assignee: CHISSO CORPORATION, Osaka (JP)

(21) Appl. No.: 12/056,961

(22) Filed: Mar. 27, 2008

(30) Foreign Application Priority Data
Apr. 12, 2007 (JP) JP2007-104716
Mar. 26, 2008 (JP) JP2007-326189

(51) Int. Cl. C08L 37/00; C08L 41/00

(52) U.S. Cl. 524/547; 524/548; 524/543

(57) ABSTRACT

An ink-jet ink suitable for forming a cured film with a balance of flame resistance, adhesion, chemical resistance, heat resistance, and softness, and a cured film with an excellent balance of the above properties are provided. The ink-jet ink of the invention contains larger than or equal to 10 wt % of a compound of formula (1) as follows:

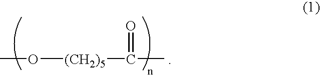

### CROSS-REFERENCE TO RELATED APPLICATION

This application claims the priority benefit of Japan application serial no. JP2007-104716, filed Apr. 12, 2007 and serial no. JP2007-326189 filed Dec. 18, 2007. All disclosure of the Japan applications is incorporated herein by reference.

### BACKGROUND OF THE INVENTION

1. Field of the Invention

The invention generally relates to an ink-jet ink, in particular, to an ink-jet ink suitable for manufacturing liquid crystal display (LCD) devices, electroluminance (EL) display devices, printed circuit boards, and so on. Furthermore, the invention relates to a cured film formed by using an ink-jet ink, an electronic circuit board with a cured film formed thereon, and an electronic component with the electronic circuit board.

2. Description of Related Art

Generally, the covering layer or insulating layer used in the electronic circuit board is required to have features of flame resistance, adhesion, chemical resistance, heat resistance, and so on. Especially for the covering layer or insulating layer formed on a flexible substrate, besides the above features, it is further required to have softness. In recent years, an ink-jet printing process as a method of forming a patterned cured film when manufacturing an electronic circuit board has been proposed because an ink-jet printing process has the advantages of low capital investment on equipments and high material utilization efficiency. A method of forming a patterned cured film using an ink-jet printing process and a composition (an ink-jet ink) used in such method has also been proposed (for example, WO 2004/099272 pamphlet), and Japanese Laid-Open Patent Application No. 2006-307152). However, the cured film formed by these ink-jet inks does not have sufficient softness.

### SUMMARY OF THE INVENTION

Accordingly, the invention is directed to a cured film with a balance of flame resistance, adhesion, chemical resistance, heat resistance, and softness, and an ink-jet ink suitable for forming the cured film with the above features.

The inventors of the invention found that, a cured film formed by an ink-jet ink containing a compound of a special structure has excellent softness, and thus the invention is completed based upon this idea.

As embodied and broadly described herein, the invention provides an ink-jet ink described as follows.

1. An ink-jet ink, containing larger than or equal to 10 wt % of a compound (A) with a structure of formula (1).

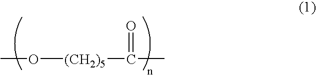

In formula (1), n is an integer of 1-10.

2. The ink-jet ink according to Item 1, the compound (A) with a structure of formula (1) has a free radical polymerizable double bond.

3. The ink-jet ink according to Item 1 or 2, the compound (A) has three or more structures of formula (1).

4. The ink-jet ink according to Item 2, the compound (A) with a structure of formula (1) is a compound of formula (2), (3), (4), or (5).

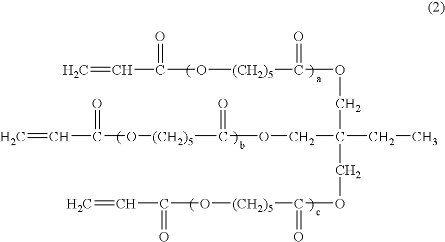

In formula (2), a, b, and c are independently integers of 0-10, and a+b+c≧1.

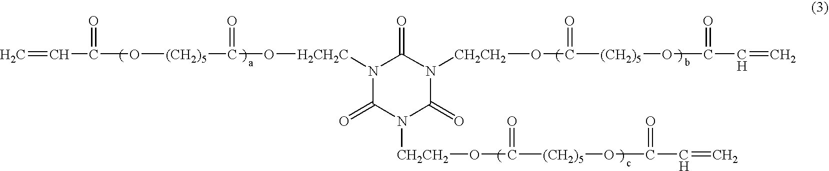

In formula (3), a, b, and c are independently integers of 0-10, and a+b+c≧1.

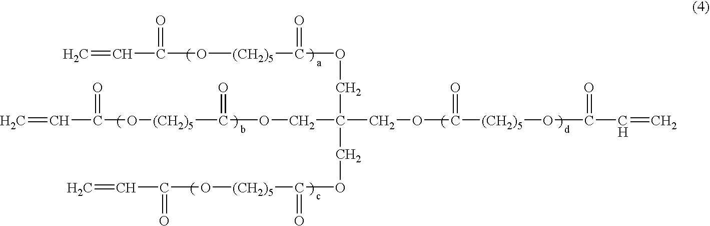

In formula (4), a, b, c, and d are independently integers of 0-10, and a+b+c+d≧1.

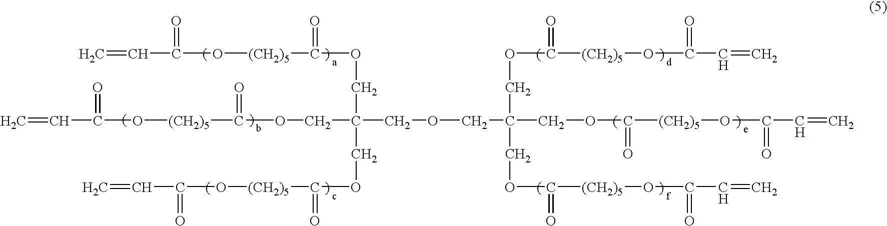

In formula (5), a, b, c, d, e, and f are independently integers of 0-10, and a+b+c+d+e+f≧1.

5. The ink-jet ink according to any one of Items 1 to 3, the compound (A) with a structure of formula (1) contains phosphorus.

6. The ink-jet ink according to Item 5, the compound (A) with a structure of formula (1) is a compound of formula (6), (7), (8), or (9).

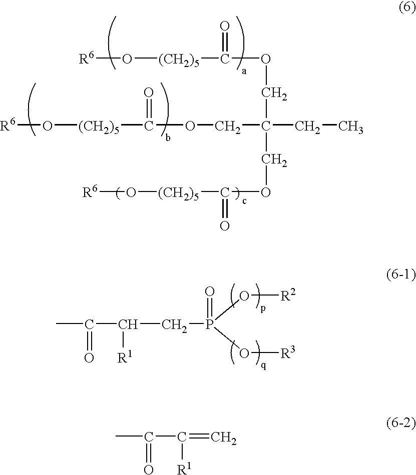

In formula (6), a, b, and c are independently integers of 0-10, a+b+c≧1, R⁶ has r groups of formula (6-1), and s groups of formula (6-2), r is an integer of 1-3, s is an integer of 0-2, (r+s) equals to 3, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ may be integrated to form a cyclic group, p and q are independently 0 or 1.

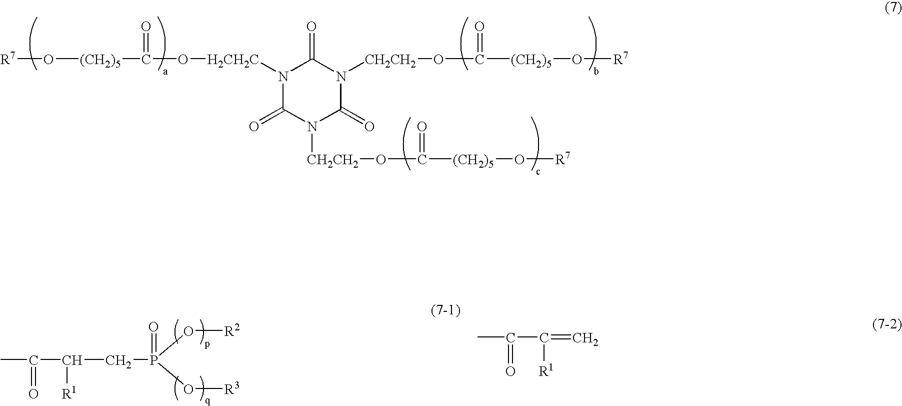

In formula (7), a, b, and c are independently integers of 0-10, a+b+c≧1, R⁷ has r groups of formula (7-1), and s groups of formula (7-2), r is an integer of 1-3, s is an integer of 0-2, (r+s) equals to 3, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ may be integrated to form a cyclic group, p and q are independently 0 or 1.

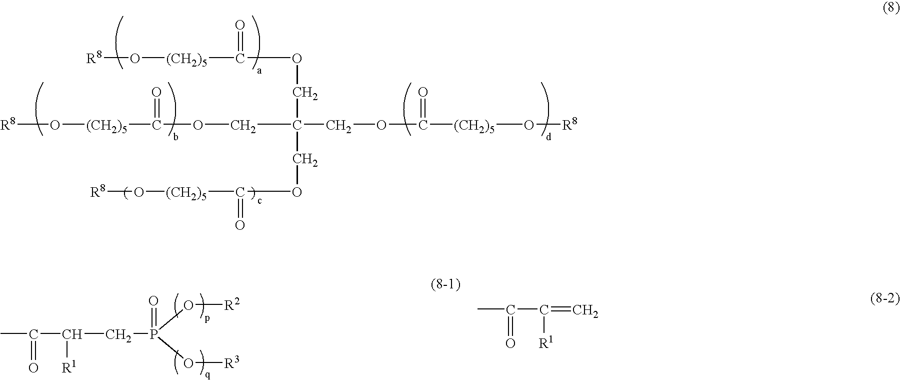

In formula (8), a, b, c, and d are independently integers of 0-10, a+b+c+d≧1, R⁸ has r groups of formula (8-1), and s groups of formula (8-2), r is an integer of 1-4, s is an integer of 0-3, (r+s) equals to 4, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ may be integrated to form a cyclic group, p and q are independently 0 or 1.

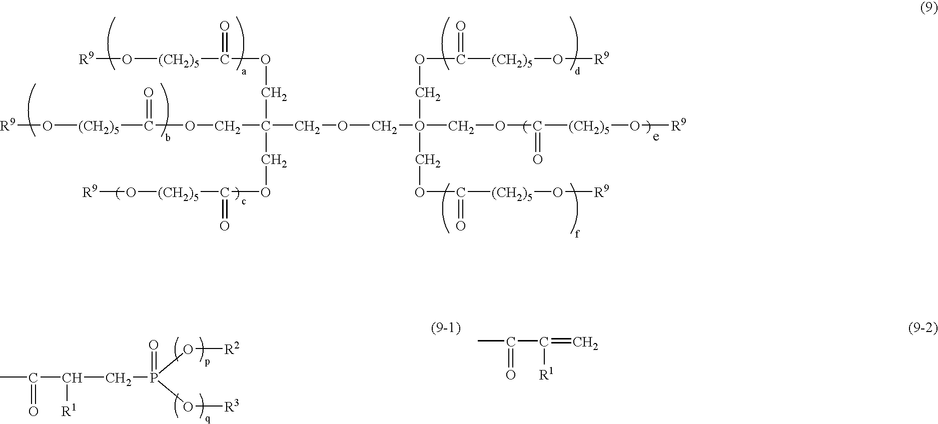

In formula (9), a, b, c, d, e, and f are independently integers of 0-10, a+b+c+d+e+f≧1, R⁹ has r groups of formula (9-1), and s groups of formula (9-2), r is an integer of 1-6, s is an integer of 0-5, (r+s) equals to 6, R¹ is hydrogen or methyl, R² and R³ are independently alkyl having 1-20 carbon atoms, phenyl, phenyl with any hydrogen substituted by alkyl having 1-5 carbon atoms or phenyl with any hydrogen substituted by phenyl, R² and R³ may be integrated to form a cyclic group, and p and q are independently 0 or 1.

7. The ink-jet ink according to Item 6, the group of formula (6-1), (7-1), (8-1), or (9-1) in formula (6), (7), (8), or (9) is the group of formula (10).

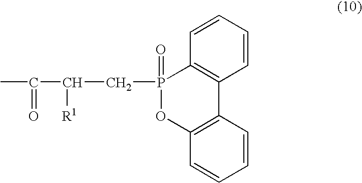

In formula (10), R¹ is hydrogen or methyl.

8. The ink-jet ink according to any one of Items 1 to 7, further contain a monomer (B) with a free radical polymerizable double bond.

9. The ink-jet ink according to Item 9, the monomer (B) with a free radical polymerizable double bond also has a thermosetting functional group.

10. The ink-jet ink according to Item 9, the thermosetting functional group is one or more selected from a group consisting of hydroxyl, carboxyl, amino, alkoxyl, oxirane, and oxetane.

11. The ink-jet ink according to Item 8, the monomer (B) with a free radical polymerizable double bond is a compound of formula (11) or a compound of formula (12).

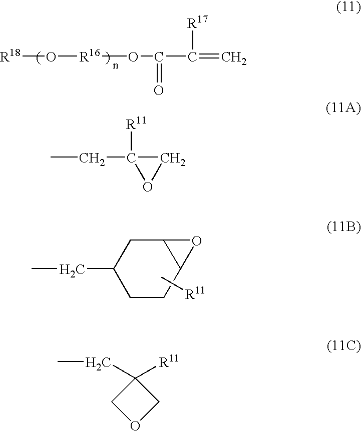

In formula (11), R¹⁶ is independently alkylene having 2-12 carbon atoms that may have a cyclic structure, R¹⁷ is alkyl having 1-3 carbon atoms or hydrogen, n is an integer of 0-30, R¹⁸ is hydrogen or any one of the groups of formulas (11A)-(11C), and in formulas (11A)-(11C), R¹¹ is independently hydrogen or alkyl having 1-5 carbon atoms, when n is larger than or equal to 2, R¹⁶ may be the same or different structures.

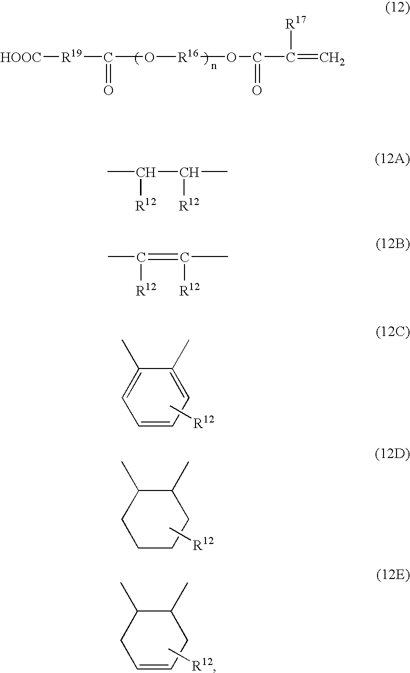

In formula (12), R¹⁶ is independently alkylene having 2-12 carbon atoms that may have a cyclic structure, R¹⁷ is alkyl having 1-3 carbon atoms or hydrogen, n is an integer of 1-30, R¹⁹ is any one of the groups of formulas (12A)-(12E), and in formulas (12A)-(12E), R¹² is independently hydrogen or alkyl having 1-5 carbon atoms, when n is larger than or equal to 2, R¹⁶ may be the same or different structures.

12. The ink-jet ink according to Item 11, in formula (11), R¹⁶ is ethylene, propylene, butylene, or a group of formula (B), R¹⁷ is hydrogen or methyl, n is an integer of 1-5, and R¹⁸ is hydrogen; in formula (12), R¹⁶ is ethylene, propylene, butylene, or a group of formula (B), R¹⁷ is hydrogen or methyl, n is an integer of 1-5, R¹⁹ is any one of the groups of formulas (12A)-(12E), and in formulas (12A)-(12E), R¹² is independently hydrogen or methyl.

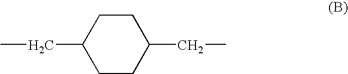

13. The ink-jet ink according to Item 8, the ink-jet ink contains a monomer (B) with a free radical polymerizable double bond that is one or more polymerizable monomers selected from a group consisting of 2-hydroxyethyl(meth)acrylate, 2-hydroxypropyl(meth)acrylate, 4-hydroxybutyl(meth)acrylate, cyclohexanedimethanol mono(meth)acrylate, 2-(meth)acryloxy ethylsuccinic acid, 2-(meth)acryloxy ethylmaleic acid, 2-(meth)acryloxy ethylphthalic acid, 2-(meth)acryloxy ethylhexahydrophthalic acid, and 2-(meth)acryloxy ethyltetrahydrophthalic acid.

14. The ink-jet ink according to any one of Items 1 to 13, the ink-jet ink further contains dual-functional (meth)acrylate.

15. The ink-jet ink according to Item 14, in which the dual-functional (meth)acrylate is one or more selected from a group consisting of bisphenol F oxirane modified di(meth)acrylate, bisphenol A oxirane modified di(meth)acrylate, oxirane isocyanurate modified di(meth)acrylate, 1,4-butanediol di(meth)acrylate, 1,6-hexanediol di(meth)acrylate, and 2,2-dimethyl-1,3-propanediol di(meth)acrylate.

16. The ink-jet ink according to any one of Items 1 to 15, the ink-jet ink further contains an alkenyl substituted nadi-imide compound.

17. The ink-jet ink according to Item 16, the alkenyl substituted nadi-imide compound is a compound of formula (20).

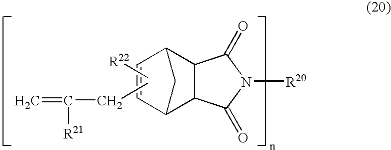

In formula (20), R²¹ and R²² are independently hydrogen, alkyl having 1-12 carbon atoms, alkenyl having 3-6 carbon atoms, cycloalkyl having 5-8 carbon atoms, aryl having 6-12 carbon atoms or benzyl, R²⁰ is an organic group having 1-300 carbon atoms, and n is an integer of 1-4.

18. The ink-jet ink according to Item 16, the alkenyl substituted nadi-imide compound is a compound of formula (21).

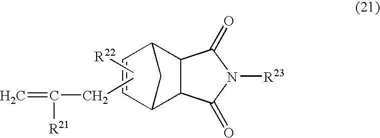

In formula (21), R²¹ and R²² are independently hydrogen, alkyl having 1-12 carbon atoms, alkenyl having 3-6 carbon atoms, cycloalkyl having 5-8 carbon atoms, aryl having 6-12 carbon atoms or benzyl, R²³ is hydrogen, alkyl having 1-12 carbon atoms, hydroxyalkyl having 1-12 carbon atoms, cycloalkyl having 5-8 carbon atoms, aryl having 6-12 carbon atoms, benzyl, a group of —{(CH₂)_{q}Oₜ(CH₂)ᵣOᵤ(CH₂)ₛX (in which q, r, and s are independently integers of 2-6, t is an integer of 0 or 1, u is an integer of 1-30, X is hydrogen or —OH), a group of —(R)ₐ—C₆H₄—R⁴ (in which a is an integer of 0 or 1, R is alkylene having 1-4 carbon atoms, R⁴ is hydrogen or alkyl having 1-4 carbon atoms), a group of formula (A), or the above groups with 1-3 hydrogens directly bonded to the aromatic ring being substituted by —OH.

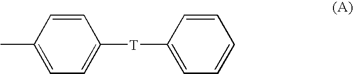

In formula (A), T is a group of —CH₂—, —C(CH₃)₂—, —CO—, —S—, or —SO₂—.

19. The ink-jet ink according to Item 16, the alkenyl substituted nadi-imide compound is a compound of formula (22).

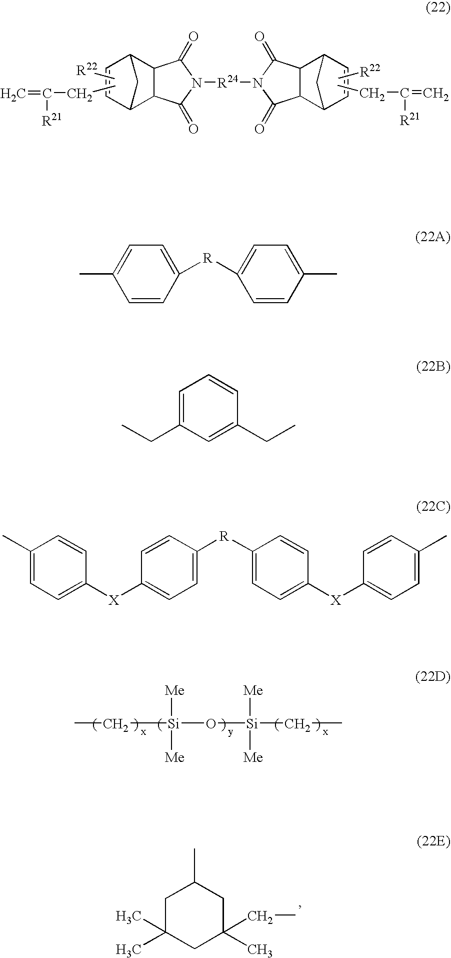

In formula (22), R²¹ and R²² are independently hydrogen or alkyl having 1-6 carbon atoms respectively; R²⁴ is alkylene having 2-15 carbon atoms (in which any methylene in the alkylene not adjacent to each other may be substituted by —O— or —CH═CH—, and any hydrogen may be substituted by fluorine), a group of formula (22A), a group of formula (22B), a group of formula (22C), a group of formula (22D), or a group of formula (22E).

In formulas (22A) and (22C), R is —CH₂—, —CH₂CH₂—, —O—, —C(CH₃)₂—, —C(CF₃)₂—, or —SO₂—; in formula (22C), X is independently —CH₂— or —O— respectively; and in formula (22D), x is independently an integer of 1-6 respectively, and y is an integer of 1-70.

20. The ink-jet ink according to Item 16, the alkenyl substituted nadi-imide compound is a compound of formula (23).

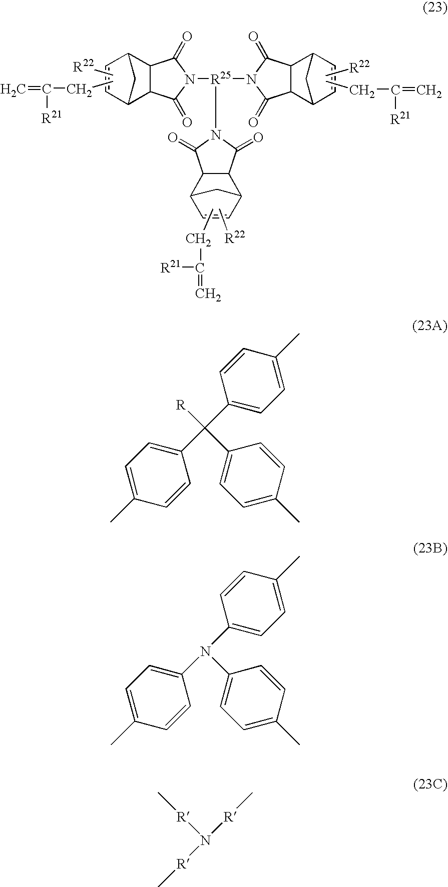

In formula (23), R²¹ and R²² are independently hydrogen or alkyl having 1-6 carbon atoms respectively, R²⁵ is a group of formula (23A), a group of formula (23B), or a group of formula (23C).

In formula (23A), R is alkyl having 1-10 carbon atoms or —OH; and in formula (23C), R′ is independently 1,2-ethylene or 1,4-butylene.

21. The ink-jet ink according to Item 16, the alkenyl substituted nadi-imide compound is a compound of formula (24).

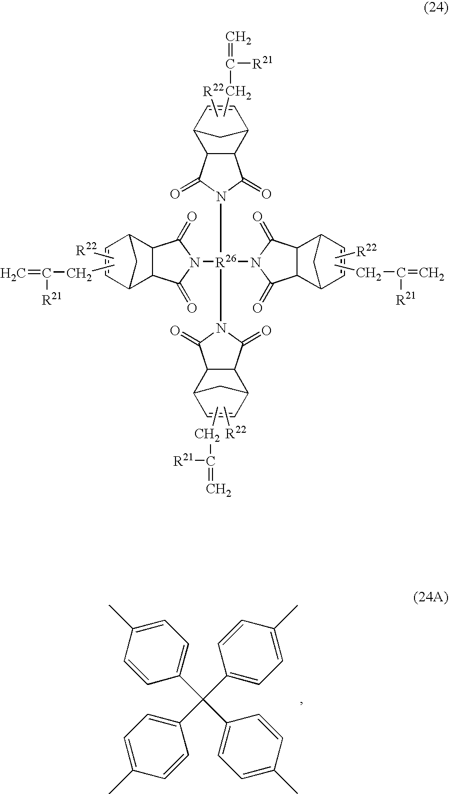

In formula (24), R²¹ and R²² are independently hydrogen or alkyl having 1-6 carbon atoms respectively, and R²⁶ is a group of formula (24A).

22. The ink-jet ink according to Item 16, the alkenyl substituted nadi-imide compound is a compound obtained by the reaction of monoamine, diamine, triamine, or tetramine with a compound of formula (25).

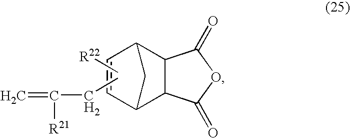

In formula (25), R²¹ and R²² are independently hydrogen, alkyl having 1-12 carbon atoms, alkenyl having 3-6 carbon atoms, cycloalkyl having 5-8 carbon atoms, aryl having 6-12 carbon atoms or benzyl respectively.

23. The ink-jet ink according to any one of Items 1 to 22, the photo-curable ink-jet ink further contains at least a bismaleimide compound.

24. The ink-jet ink according to Item 23, the bismaleimide compound is a compound of formula (30).

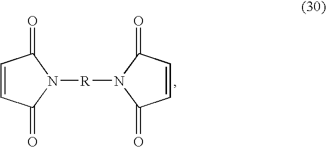

In formula (30), R is a bivalent organic group with 2-30 carbon atoms.

25. The ink-jet ink according to Item 24, R in formula (30) is selected from a group consisting of the following groups:

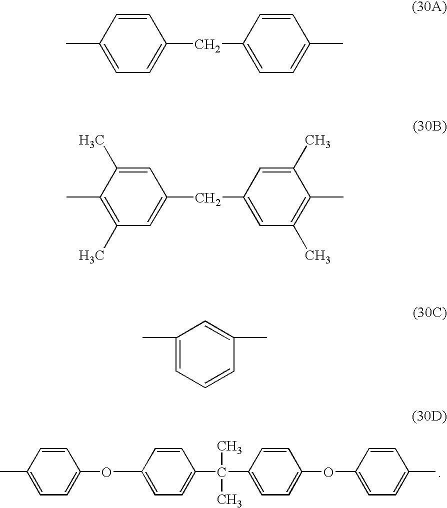

26. The ink-jet ink according to any one of Items 1 to 25, the ink-jet ink further contains a photo-polymerization initiator (C).

27. The ink-jet ink according to Item 26, the photo-polymerization initiator (C) is bis(2,4,6-trimethylbenzoyl)phenyl phosphine oxide or 2,4,6-trimethylbenzoyl diphenyl phosphine oxide.

28. The ink-jet ink according to Item 26, the compound (A) with a structure of formula (1) is one selected from the compounds of formula (6) or (9), or a mixture thereof, a monomer (B) with a free radical polymerizable double bond is one selected from 4-hydroxybutyl(meth)acrylate and 1,4-cyclohexanedimethanol mono(meth)acrylate, or a mixture thereof, and the photo-polymerization initiator (C) is one selected from bis(2,4,6-trimethylbenzoyl)phenyl phosphine oxide and 2,4,6-trimethylbenzoyl diphenyl phosphine oxide, or a mixture thereof.

29. The ink-jet ink according to any one of Items 1 to 28, the ink-jet ink is free of a solvent with a boiling point lower than or equal to 300° C. at a normal pressure, or the content of a solvent with a boiling point lower than or equal to 300° C. at a normal pressure is less than or equal to 10 wt %.

30. An electronic circuit board has a cured film formed thereon by using the ink-jet ink according to any one of Items 1 to 29.

31. An electronic component has the electronic circuit board according to Item 30.

32. A display device has the electronic component according to Item 31.

Furthermore, in this specification, (meth)acrylate represents both acrylates and methacrylates.

In an Example of the invention, as the cured film formed by using the ink-jet ink of the invention has excellent softness and a desired balance of flame resistance, adhesion, chemical resistance, heat resistance, the cured film can be safely used as a material for an electronic circuit board.

### BRIEF DESCRIPTION OF THE DRAWINGS

No drawings.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

1. Compound (A) with a Structure of Formula (1)

The compound (A) used in the ink-jet ink of the invention is a compound with a structure of formula (1). The cured film formed by the ink-jet ink containing the compound with such structure has desired softness. Preferably, the compound (A) further contains a compound with a free radical polymerizable double bond, such that the cured film formed thereby has a higher heat resistance. Most preferably, the compound (A) is a compound with three or more structures of formula (1), for example, the compounds of formula (2), (3), (4), or (5). Especially, the compound (A) is preferably a compound of formula (6), (7), (8), or (9), such that the cured film has high flame resistance. Preferably, the group of formula (6-1), (7-1), (8-1), or (9-1) in formula (6), (7), (8), or (9) is a group of formula (10), and the chemical resistance is high. The compound (A) used in the ink-jet ink of the invention may be a single compound, and may also be a mixture of two or more compounds. The content of the compound (A) is preferably larger than or equal to 10 wt %, such that the formed cured film has a high softness. Considering the balance of softness and other properties, the content of the compound (A) is preferably 15-80 wt %, and more preferably 20-70 wt %.

2. Monomer (B) with a Free Radical Polymerizable Double Bond

In order to adjust the inkjet ink of the invention to have a proper viscosity to meet the actual applications, the ink-jet ink may contain a monomer (B) with a free radical polymerizable double bond. The monomer (B) with a free radical polymerizable double bond specifically includes glycidyl(meth)acrylate, 3,4-epoxycyclohexyl(meth)acrylate, methylglycidyl(meth)acrylate, 3-methyl-3-(meth)acryloxy methyloxetane, 3-ethyl-3-(meth)acryloxy methyloxetane, 3-methyl-3-(meth)acryloxy ethyloxetane, 3-ethyl-3-(meth)acryloxy ethyloxetane, p-vinylphenyl-3-ethyl epoxyprop-3-ylmethyl ether, 2-phenyl-3-(meth)acryloxy methyloxetane, 2-trifluoromethyl-3-(meth)acryloxy methyloxetane, 4-trifluoromethyl-2-(meth)acryloxy methyloxetane, (meth)acrylatic acid, methyl(meth)acrylate, ethyl(meth)acrylate, isopropyl(meth)acrylate, butyl(meth)acrylate, isobutyl(meth)acrylate, t-butyl(meth)acrylate, cyclohexyl(meth)acrylate, benzyl(meth)acrylate, styrene, methylstyrene, chloromethylstyrene, (3-ethyl-3-oxetane)methyl(meth)acrylate, N-cyclohexyl maleimide, N-phenyl maleimide, vinyltoluene, tricyclo[5.2.1.0^{2,6}]decanyl(meth)acrylate, dicyclopentenyloxyethyl(meth)acrylate, isobornyl(meth)acrylate, phenyl(meth)acrylate, glycerol mono(meth)acrylate, polystyrene macromonomer, polymethyl methacrylate macromonomer, 5-tetrahydrofurfuryloxycarbonylpentyl(meth)acrylate, (meth)acrylate of ethylene oxide adduct of lauryl alcohol, (meth)acrylic acid, crotonic acid, α-chloroacrylic acid, cinnamic acid, maleic acid, fumaric acid, itaconic acid, citraconic acid, mesaconic acid, ω-carboxyl polycaprolactone mono(meth)acrylate, mono[2-(meth)acryloxy ethyl]succinate, mono[2-(meth)acryloxy ethyl]maleate, mono[2-(meth)acryloxy ethyl]cyclohexylene-3,4-bicarbonate, (meth)acrylamide, N,N-dimethyl(meth)acrylamide, N,N-diethyl(meth)acrylamide, N,N-dimethylamine propyl(meth)acrylamide, N-isopropyl(meth)acrylamide, N-acryloyl morpholine, N-phenyl maleimide, N-cyclohexyl maleimide, 2-hydroxyethyl(meth)acrylate, 2-hydroxypropyl(meth)acrylate, 4-hydroxybutyl(meth)acrylate, 1,4-cyclohexanedimethanol mono(meth)acrylate, and N-hydroxyethyl(meth)acrylate. Considering the high adhesion of the cured film with the base material, 2-hydroxyethyl(meth)acrylate, 2-hydroxypropyl(meth)acrylate, 4-hydroxybutyl(meth)acrylate, 1,4-cyclohexanedimethanol mono(meth)acrylate are preferred, and 4-hydroxybutyl(meth)acrylate or 1,4-cyclohexanedimethanol mono(meth)acrylate is the most preferred.

The monomer (B) with a free radical polymerizable double bond used in the invention may be a single compound and may also be a mixture of two or more compounds. Preferably, the content of the monomer (B) with a free radical polymerizable double bond is 10-70 wt % based on the total weight of the ink-jet ink, so that the viscosity of the ink-jet ink can be adjusted to a viscosity suitable for practical use. Considering the balance of the viscosity and other properties, the content of the monomer (B) with a free radical polymerizable double bond is more preferably 20-60 wt %.

3. Photo-Polymerization Initiator (C)

In order to enable the ink-jet ink of the invention to have the photo-curable property, the ink-jet ink may contain a photo-polymerization initiator (C). The photo-polymerization initiator (C) is not particularly restricted, as long as it is a compound capable of generating free radicals upon being irradiated by UV lights or visible lights. The photo-polymerization initiator (C) includes, for example, benzophenone, Michler's ketone, 4,4′-bis(diethylamino)benzophenone, xanthone, thioxanthone, isopropylxanthone, 2,4-diethylthioxanthone, 2-ethyl anthraquinone, acetophenone, 2-hydroxy-2-methylpropiophenone, 2-hydroxy-2-methyl-4′-isopropylpropiophenone, 1-hydroxy cyclohexylphenyl ketone, isopropyl benzoin ether, isobutyl benzoin ether, 2,2-diethoxyacetophenone, 2,2-dimethoxy-2-phenylacetophenone, camphorquinone, benzanthrone, 2-methyl-1-[4-(methylthio)phenyl]-2-morpholinylpropan-1-one, 2-benzyl-2-dimethylamino-1-(4-morpholinylphenyl)-butanone-1, ethyl 4-dimethylaminobenzoate, isoamyl 4-dimethylaminobenzoate, 4,4′-di-(t-butylperoxycarbonyl)benzophenone, 3,4,4′-tri(t-butylperoxycarbonyl)benzophenone, 3,3′,4,4′-tetra(t-butylperoxycarbonyl)benzophenone, 3,3′,4,4′-tetra(t-hexylperoxycarbonyl)benzophenone, 3,3′-di(methoxycarbonyl)-4,4′-di(t-butylperoxycarbonyl)benzophenone, 3,4′-di(methoxycarbonyl)-4,3′-di(t-butylperoxycarbonyl)benzophenone, 4,4′-di(methoxycarbonyl)-3,3′-di(t-butylperoxycarbonyl)benzophenone, 1,2-octadione, 1-[4-(phenylthio)phenyl], 2-(o-benzoyloxime), 2-(4′-methoxystyrenyl)-4,6-bis(trichloromethyl)-s-triazine, 2-(3′,4′-dimethoxystyrenyl)-4,6-bis(trichloromethyl)-s-triazine, 2-(2′,4′-dimethoxystyrenyl)-4,6-bis(trichloromethyl)-s-triazine, 2-(2′-methoxystyrenyl)-4,6-bis(trichloromethyl)-s-triazine, 2-(4′-pentyloxystyrenyl)-4,6-bis(trichloromethyl)-s-triazine, 4-[p-N,N-di-(ethoxycarbonylmethyl)]-2,6-di-(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyrenyl)benzoxazole, 2-(p-dimethylaminostyrenyl)benzothiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetrakis(4-ethoxycarbonylphenyl)-1,2′-biimidazole, 2,2′-bis(2,4-dichlorophenyl)-4,4′,5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylaminopropanoyl)carbazole, 3,6-bis(2-methyl-2-morpholinylpropanoyl)-9-n-dodecylcarbazole, 1-hydroxy cyclohexylphenyl ketone, bis(η⁵-2,4-cyclopentadien-1-yl)-bis(2,6-difluoro-3-(1H-pyrrol-1-yl)-phenyl)titanium, bis(2,4,6-trimethylbenzoyl)phenyl phosphine oxide, or 2,4,6-trimethylbenzoyl diphenyl phosphine oxide. Preferably, the photo-polymerization initiator (C) is bis(2,4,6-trimethylbenzoyl)phenyl phosphine oxide or 2,4,6-trimethylbenzoyl diphenyl phosphine oxide, which are photo-polymerization initiators (C) containing a phosphorus atom, such that the flame resistance of the formed cured film is improved.

The photo-polymerization initiator (C) used in the invention may be a single compound and may also be a mixture of two or more compounds. Preferably, the content of the photo-polymerization initiator (C) is larger than or equal to 1 wt % based on the total weight of the ink-jet ink, and thus less UV lights are required for curing the ink-jet ink. Considering the balance of the curable property and other properties, the content of the photo-polymerization initiator (C) is more preferably 1-20 wt %.

4. Alkenyl Substituted Nadi-Imide Compound

The ink-jet ink of the invention may further contain an alkenyl substituted nadi-imide compound. The alkenyl substituted nadi-imide compound preferably includes, for example, the compounds of formula (20), (21), (22), (23), or (24), or a compound obtained by reacting monoamine, diamine, triamine, or teteramine with the compound of formula (25).

The alkenyl substituted nadi-imide compound can be synthesized by a well-known method, for example, obtained by reacting monoamine, diamine, triamine, or teteramine with the compound of formula (25).

The content of the alkenyl substituted nadi-imide compound is preferably 5-50 wt % based on the total weight of the polymerizable monomer, so that the formed cured film has high heat resistance and high insulation property.

5. Bismaleimide Compound

The ink-jet ink of the invention may further contain a bismaleimide compound. The bismaleimide compound contained in the photo-curable ink-jet ink of the invention includes the compound of formula (30), for example, m-phenylene bismaleimide, 4,4′-diphenylmethane bismaleimide.

The content of the bismaleimide compound is preferably 5-50 wt % based on the total weight of the polymerizable monomer, so that the formed cured film has high heat resistance and high insulation property.

6. Other Ingredients

In order to improve the properties of the ink-jet ink of the invention, the ink-jet ink of the invention may contain multifunctional (meth)acrylate, a compound with two or more oxirane or oxetane, an epoxy curing agent, a surfactant, a coupling agent, a colorant, a polymerization inhibitor, a solvent, and so on.

6.1 Multifunctional (Meth)Acrylate

Preferably, the ink-jet ink may contain a multifunctional (meth)acrylate, such that less UV lights are required to cure the ink-jet ink. The multifunctional (meth)acrylate specifically includes, for example, ethylene oxide isocyanurate modified di(meth)acrylate, pentaerythritol di(meth)acrylate, pentaerythritol di(meth)acrylate monostearate, pentaerythritol tri(meth)acrylate, trimethylolpropane di(meth)acrylate, dipentaerythritol di(meth)acrylate, dipentaerythritol tri(meth)acrylate, dipentaerythritol tetra(meth)acrylate, dipentaerythritol penta(meth)acrylate, bisphenol F ethylene oxide modified diacrylate, bisphenol A ethylene oxide modified diacrylate, polyethylene glycol diacrylate, polypropylene glycol diacrylate, 1,4-butanediol diacrylate, 1,6-hexanediol diacrylate, 1,9-nonanediol diacrylate, 1,4-cyclohexane dimethanol diacrylate, 2-n-butyl-2-ethyl-1,3-propylene glycol diacrylate, trimethylolpropane tri(meth)acrylate, ethylene oxide modified trimethylolpropane tri(meth)acrylate, propylene oxide modified trimethylolpropane tri(meth)acrylate, epichlorohydrin modified trimethylolpropane tri(meth)acrylate, di-(trimethylolpropane) tetra(meth)acrylate, glycerol tri(meth)acrylate, epichlorohydrin modified glycerol tri(meth)acrylate, diglycerol tetra(meth)acrylate, pentaerythritol tetra(meth)acrylate, dipentaerythritol hexa(meth)acrylate, ethylene oxide modified phosphate tri(meth)acrylate, tris[(meth)acryloxy ethyl]isocyanurate, or urethane(meth)acrylate. Preferably, the multifunctional (meth)acrylate is diglycerol tetra(meth)acrylate, pentaerythritol tetra(meth)acrylate, dipentaerythritol hexa(meth)acrylate, or tri[(meth)acryloxy ethyl]isocyanurate, such that less UV lights are required to cure the ink-jet ink.

The multifunctional (meth)acrylate used in the invention may be a single compound and may also be a mixture of two or more compounds. The content of the multifunctional (meth)acrylate is preferably larger than or equal to 10 wt % based on the total weight of the ink-jet ink, such that less UV lights are required to cure the ink-jet ink. Considering the balance of the curable property and other properties, the content of the multifunctional (meth)acrylate is more preferably 10-50 wt %.

6.2 Compound with Two or More Oxirane and Oxetane

In order to get a cured film with high chemical resistance, the compound with two or more oxirane and oxetane used in the ink-jet ink of the invention is preferably a multifunctional epoxy resin. The epoxy resin used in the invention specifically includes, for example, bisphenol A epoxy resin, glycidyl ester epoxy resin, alicyclic epoxy resin. Such epoxy resin specifically includes, for example, products with Trade Name of EPIKOTE 807, EPIKOTE 815, EPIKOTE 825, EPIKOTE 827, EPIKOTE 828, EPIKOTE 190P, EPIKOTE 191P (manufactured by Yuka-Shell Epoxy Co., Ltd.); products with Trade Name of EPIKOTE 1004, EPIKOTE 1256 (manufactured by Japan Epoxy Resins Co., Ltd.); products with Trade Name of Araldite CY177, Araldite CY184 (manufactured by Nihon Ciba-Geigy Co., Ltd.); products with Trade Name of Celloxide 2021P, EHPE-3150 (manufactured by Daicel Chemical Industries Co., Ltd.); or products with Trade Name of Tecmore VG3101L (manufactured by Mitsui Chemicals Co., Ltd.). Preferably, the epoxy resin is EPIKOTE 828, Araldite CY184, Tecmore VG3101L, or Celloxide 2021P, such that the formed cured film has high heat resistance and high chemical resistance.

The compound with two or more oxirane or oxetane used in the inkjet ink of the invention may be a single compound, and may also be a mixture of two or more compounds. The content of the compound with two or more oxirane and oxetane is preferably larger than or equal to 5 wt % based on the total weight of the ink-jet ink, such that the chemical resistance is improved. Considering the balance of chemical resistance and other properties, the content of the compound with two or more oxirane and oxetane is more preferably 10-50 wt %.

6.3 Epoxy Curing Agent

When the ink-jet ink of the invention contains the compound with two or more oxirane and oxetane, in order to further improve the heat resistance of the cured film, the ink-jet ink of the invention may further contain an epoxy curing agent. The epoxy curing agent may include an acid anhydride type curing agent, a polyamine type curing agent, a polyphenol type curing agent, and a catalytic type curing agent, and so on. Considering the coloring property and heat resistance, the acid anhydride type curing agent is preferred.

The acid anhydride type curing agent includes, for example, maleic anhydride, tetrahydrophthalic anhydride, hexahydrophthalic anhydride, methyl hexahydrophthalic anhydride, hexahydrotrimellitic anhydride, phthalic anhydride, trimellitic anhydride, or styrene-maleic anhydride copolymer. Among the acid anhydride curing agents, the trimellitic anhydride and hexahydrotrimellitic anhydride with excellent heat resistance are preferred.

The epoxy curing agent used in the ink-jet ink of the invention may be a single compound, and may also be a mixture of two or more compounds. The content of the epoxy curing agent is preferably larger than or equal to 10 wt % of the compound with two or more oxirane or oxetane, such that the heat resistance is improved. Considering the balance of the heat resistance and other properties, the content of the epoxy curing agent is more preferably 10-50 wt %.

6.4 Surfactant

The ink-jet ink of the invention may contain a surfactant for improving the wetting property of the ink-jet ink to the substrate and the surface uniformity of the cured film. The surfactant may be a silicone type surfactant, an acrylic type surfactant, and a fluorine type surfactant, and so on. The surfactant includes, for example, the silicone type surfactant, such as products with Trade Name of BYK-300, BYK-306, BYK-335, BYK-310, BYK-341, BYK-344, and BYK-370 (manufactured by BYK-Chemie Co., Ltd.), the acrylic type surfactant, such as products with Trade Name of BYK-354, BYK-358, and BYK-361 (manufactured by BYK-Chemie Co., Ltd.), and the products with Trade Name of DFX-18, Ftergent 250, or Ftergent 251 (manufactured by Neos Co., Ltd.).

The surfactant used in the ink-jet ink of the invention may be a single compound, and may also be a mixture of two or more compounds. The content of the surfactant in the ink-jet ink is preferably larger than or equal to 0.01 wt %, such that the surface uniformity of the cured film is improved. Considering the balance of the surface uniformity and other properties, the content of the surfactant is more preferably 0.01-1 wt %.

6.5 Coupling Agent

The ink-jet ink of the invention may also contain a coupling agent for improving the adhesion with the substrate. The coupling agent may be silane type compounds, aluminum type compounds, or titanate type compounds. The coupling agent specifically includes, for example, silane type compounds, such as 3-glycidoxypropyl dimethylethoxysilane, 3-glycidoxypropyl methyldiethoxysilane, or 3-glycidoxypropyl trimethoxysilane; aluminum type compounds, such as acetalkoxyaluminium isopropoxide; and titanate type compounds, such as tetraisopropylbis(dioctylphosphate)titanate. Among the compounds, 3-glycidoxypropyl trimethoxysilane has good effect in improving adhesion, and thus is preferred.

The coupling agent used in the ink-jet ink of the invention may be a single compound, and may also be a mixture of two or more compounds. The content of the coupling agent is preferably larger than or equal to 0.5 wt %, such that the ink-jet ink of the invention has an improved adhesion with the substrate. Considering the balance of the adhesive property and other properties, the content of the coupling agent is more preferably 0.5-10 wt %.

6.6 Colorant

The ink-jet ink of the invention may further contain a colorant for easily distinguishing the cured film from the substrate when checking the state of the cured film. The colorant is preferably a pigment with good heat resistance. The colorant used in the ink-jet ink of the invention may be a single compound, and may also be a mixture of two or more compounds. The content of the colorant is preferably larger than or equal to 1 wt % based on the total weight of the ink-jet ink, such that the checking process of the cured film is easily performed. Considering the balance of easily performed checking process and other properties, the content of the colorant is more preferably 1 wt %-10 wt %.

6.7 Polymerization Inhibitor

The ink-jet ink of the invention may further contain a polymerization inhibitor for improving the storage stability. The polymerization inhibitor specifically includes, for example, 4-methoxyphenol, hydroquinone, phenothiazine, and so on. Among such polymerization inhibitors, phenothiazine can enable the ink-jet ink to have smaller changes in viscosity even after long-term storage, which thus is preferred. The polymerization inhibitor used in the ink-jet ink of the invention may be a single compound, and may also be a mixture of two or more compounds. The content of the polymerization inhibitor is preferably larger than or equal to 0.01 wt % based on the total weight of the ink-jet ink, such that the ink-jet ink has smaller changes in viscosity during long-term storage. Considering the balance of the changing in viscosity and other properties, the content of the polymerization inhibitor is more preferably 0.01-1 wt %.

6.8 Solvent

The ink-jet ink of the invention may further contain a solvent for enabling the ink-jet ink of the invention to have a viscosity suitable for ink-jet printing. The solvent contained in the ink-jet ink of the invention preferably has a boiling point of 100° C.-300° C.

The solvent with a boiling point of 100° C.-300° C. specifically includes, for example, water, butyl acetate, butyl propionate, ethyl lactate, methyl oxyacetate, ethyl oxyacetate, butyl oxyacetate, methyl methoxyacetate, ethyl methoxyacetate, butyl methoxyacetate, methyl ethoxyacetate, ethyl ethoxyacetate, methyl 3-oxypropionate, ethyl 3-oxypropionate, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, methyl pyruvate, ethyl pyruvate, propyl pyruvate, methyl acetoacetate, ethyl acetoacetate, methyl 2-oxobutyrate, ethyl 2-oxobutyrate, dioxane, ethylene glycol, diethylene glycol, triethylene glycol, propylene glycol, dipropylene glycol, tripropylene glycol, 1,4-butanediol, ethylene glycolmonoisopropyl ether, ethylene glycolmonobutyl ether, propylene glycol monomethyl ether, propylene glycol monomethyl ether acetate, propylene glycol monoethyl ether acetate, propylene glycol monopropyl ether acetate, dipropylene glycol monoethyl ether acetate, dipropylene glycol monobutyl ether acetate, ethylene glycol monobutyl ether acetate, cyclohexanone, cyclopentanone, diethylene glycol monomethyl ether, diethylene glycol monomethyl ether acetate, diethylene glycol monoethyl ether, diethylene glycol monoethyl ether acetate, diethylene glycol monobutyl ether, diethylene glycol monobutyl ether acetate, diethylene glycol dimethyl ether, diethylene glycol diethyl ether, diethylene glycol methylether, toluene, xylene, anisole, γ-butyrolactone, N,N-dimethylacetamide, N-methyl-2-pyrrolidone, dimethyl imidazolidinone.

The solvent used in the ink-jet ink of the invention may be a compound, and may also be a mixture of two or more compounds. The content of the solvent in the ink-jet ink of the invention preferably makes the solid content to be not less than 40 wt %.

7. Ink-Jet Ink of the Invention

Depending upon the actual requirements, a monomer (B) with a free radical polymerizable double bond, a photo-polymerization initiator (C), multifunctional (meth)acrylate, a compound with two or more oxirane or oxetane, an epoxy curing agent, a surfactant, a coupling agent, a colorant, a polymerization inhibitor, and a solvent are added into and mixed and dissolved in a compound (A), and then the viscosity at 25° C. is adjusted to 2-200 mPa·s, so as to serve as an ink-jet ink. When being used as an ink-jet ink, desired patterns can be drawn, which thus is applicable for manufacturing electronic circuit boards. In order to make the ink being stably jet out of the inkjet nozzle, the viscosity of the ink-jet ink at 25° C. is preferably 2-50 mPa·s. The ink-jet ink of the invention may be colorless or may have color.

When using an ink having a viscosity at 25° C. of larger than or equal to 50 mPa·s, the inkjet nozzle is preferably heated. When heating the inkjet nozzle, if the ink contains a solvent with a low boiling point, the solvent is likely to be evaporated, and the viscosity of the ink is increased, which may further result in a blockage at the nozzle. To avoid these problems, the ink is preferably free of a solvent, or contains a small amount of solvent at a content of less than or equal to 10 wt %. When heating the inkjet nozzle, the ink preferably contains monomer (B) with a free radical polymerizable double bond for adjusting the viscosity.

When the inkjet nozzle is not heated, the viscosity of the ink may be adjusted by adding a solvent.

8. Formation of the Cured Film

The cured film of the invention may be formed by firstly coating the ink-jet ink of the invention onto the surface of the substrate through ink jet printing process, and then irradiating the ink with UV lights depending upon the actual requirements, in which the link is preferable heated with an oven or a heating plate at 150-250° C. for 10-60 min.

When the UV lights are used for irradiation, the amount of UV irradiation is measured with an UV Intensity Meter UIT-201 equipped with an optical receiver UVD-365PD (manufactured by Ushio INC. Co., Ltd), which is preferably 10 mJ/cm²-1,000 mJ/cm².

In the specification, the substrate is not specially limited, as long as it serves as an object for coating the thermosetting composition, thermosetting ink-jet ink of the invention, and the shape of the substrate may be a flat plate or a curved plate.

Furthermore, the material of the substrate used in the invention is not specially limited, which may include, for example, polyester resin, such as polyethylene terephthalate (PET), polybutylene terephthalate (PBT); polyolefin resin, such as polystyrene, polypropylene; plastic films, such as polyvinyl chloride, fluorocarbon resin, acrylic resin, polyamide, polycarbonate, polyimide; cellophane, acetate, metal foil, laminated film of polyimide and metal foil, transparent paper having filling effect, parchment paper or filling processing paper of polystyrene, clay binder, polyvinyl alcohol, starch, carboxymethyl cellulose (CMC), and glass, etc. The material for forming the substrate may further include additives, for example, pigment, dye, antioxidant, anti-aging agent, filler, UV absorber, antistatic agent, and/or electromagnetic inhibitor, without negatively influencing the invention.

The thickness of the substrate is not specially limited, but generally about 10 μm-2 mm, and it may be appropriately adjusted according to the purpose of usage, which is preferably 15 μm-500 μm, and more preferably 20 μm-200 μm.

Depending upon the actual requirements, easy-bonding treatments, such as corona treatment, plasma treatment, blasting treatment, may be performed on the surface of the substrate with the cured film formed thereon, or an easy-bonding layer is disposed thereon.

Hereinafter, the invention is further illustrated with reference to the following Examples, but the invention is not limited thereto.

### EXAMPLES

### Example 1

According to the following composition, Aronix M-327 (Trade Name, manufactured by Toagosei Co., Ltd., a mixture of compounds of formula (3), in which an average of (a+b+c) is 3) and KAYARAD DPCA-60 (Trade Name, manufactured by Nippon Kayaku Co., Ltd., a mixture of compounds of formula (5), in which an average of “a” to “f” is respectively 1) as the compound (A); 4-hydroxybutyl acrylate (hereinafter referred to as 4HBA) as the monomer (B) with a free radical polymerizable double bond; 2,4,6-trimethylbenzoyl-diphenyl phosphine oxide (Trade Name, DAROCUR TPO, hereinafter referred to as TPO, manufactured by Ciba Specialty Chemicals Co., Ltd.) as the photo-polymerization initiator; and phenothiazine as the polymerization inhibitor (C) were mixed and dissolved, and then filtered by a membrane filter (1 μm) made of fluorocarbon resin, so as to prepare an ink-jet ink 1.

| | |
|---|---|
| Aronix M-327 | 50.00 g |
| KAYARAD DPCA-60 | 50.00 g |
| 4HBA | 100.00 g |
| TPO | 10.00 g |
| Phenothiazine | 0.04 g |

The ink-jet ink 1 was injected into an inkjet cartridge, and then the inkjet cartridge was installed in an ink-jet device DMP-2811 (Trade Name, manufactured by Dimatix Company), so as to uniformly print on Kapton (registered trademark, Trade Name, manufactured by Du Pont-Toray Co., Ltd., Thick 150 μm, Type H, referred to as Kapton substrate hereinafter) as the polyimide film within a range of an area of 2 cm×5 cm. It was coated for once, and the jetting speed from the nozzle was 10 times per second, and the jetting temperature was 50° C.

At 30 mJ/cm², the printed substrate was irradiated by UV lights with a wavelength of 365 nm, and then sintered at 190° C. for 30 min, to get a Kapton substrate 1 with a cured film having a thickness of 28 μm formed thereon. Then, the Kapton substrate 1, taking the surface with the cured film formed thereon as an external surface, was wound for 100 times to form a cylinder with a radius of 1 mm. The resulting substrate was observed with a microscope, and it was confirmed that the patterns contained no cracks.

### Comparative Example 1

According to the following composition, Aronix M-315 (Trade Name, manufactured by Toagosei Co., Ltd., tris[acryloxy ethyl]isocyanurate) and Aronix M-402 (Trade Name, manufactured by Toagosei Co., Ltd., dipentaerythritol hexaacrylate) as the multifunctional acrylate, 4HBA as the monomer (B) with a free radical polymerizable double bond, TPO as the photo-polymerization initiator, and phenothiazine as the polymerization inhibitor (C) were mixed and dissolved, and then filtered by a membrane filter (1 μm) made of fluorocarbon resin, to prepare an ink-jet ink 2.

| | |
|---|---|
| Aronix M-315 | 50.00 g |
| Aronix M-402 | 50.00 g |
| 4HBA | 100.00 g |
| TPO | 10.00 g |
| Phenothiazine | 0.04 g |

The ink-jet ink 2 was processed through the same way as that in Example 1, to get a Kapton substrate 2 with a cured film having a thickness of 30 μm formed thereon. The jetting temperature was 40° C. Then, the Kapton substrate 2, taking the surface with the cured film formed thereon as an external surface, was wound for 100 times to form a cylinder with a radius of 1 mm, and then was observed with a microscope. Finally, it was found that the patterns had cracks.

### Example 2

According to the following composition, Ripoxy HFA-6127 (Trade Name, manufactured by Showa Highpolymer Co., Ltd., a mixture of the compounds of formula (9), in which an average of (a+b+c+d+e+f) is 6, an average of “r” is 4, formula (9-1) is formula (10), and R¹ in formula (10) is hydrogen, an average of “s” is 2, and R¹ in formula (9-2) is hydrogen) as the compound (A), 4HBA as the monomer (B) with a free radical polymerizable double bond, TPO as the photo-polymerization initiator (C), and phenothiazine as the polymerization inhibitor were mixed and dissolved, and then filtered by a membrane filter (1 μm) made of fluorocarbon resin, to prepare an ink-jet ink 3.

| | |
|---|---|
| Ripoxy HFA-6127 | 70.00 g |
| 4HBA | 100.00 g |
| TPO | 10.00 g |
| Phenothiazine | 0.04 g |

The ink-jet ink 3 was processed through the same way as that in Example 1, to get a Kapton substrate 3 with a cured film having a thickness of 28 μm formed thereon. The jetting temperature was 70° C. Then, the Kapton substrate 3, taking the surface with the cured film formed thereon as an external surface, was wound for 100 times to form a cylinder with a radius of 1 mm, and then was observed with a microscope. Finally, it was found that the patterns had no cracks.

### Comparative Example 2

According to the following composition, a mixture of Ripoxy HF-DPHA30 (Trade Name, manufactured by Showa Highpolymer Co., Ltd., the addition product of dipentaerythritol hexaacrylate with 9,10-dihydro-9-oxe-10-phosphaphenanthrene-10-oxide) and propylene glycol monomethyl ether acetate at a weight ratio of 80:20 as the multifunctional acrylate, 4HBA as the monomer (B) with a free radical polymerizable double bond, TPO as the photo-polymerization initiator, and phenothiazine as the polymerization inhibitor (C) were mixed and dissolved, and then filtered by a membrane filter (1 μm) made of fluorocarbon resin, to prepare an ink-jet ink 4.

| | |
|---|---|
| Ripoxy HF-DPHA30 | 70.00 g |
| 4HBA | 100.00 g |
| TPO | 10.00 g |
| Phenothiazine | 0.04 g |

The ink-jet ink 4 was processed through the same way as that in Example 1, to get a Kapton substrate 4 with a cured film having a thickness of 29 μm formed thereon. The jetting temperature was 65° C. Then, the Kapton substrate 4, taking the surface with the cured film formed thereon as an external surface, was wound for 100 times to form a cylinder with a radius of 1 mm, and then was observed with a microscope. Finally, it was found that the patterns had cracks.

### Example 3

According to the following composition, Ripoxy HFA-6127 as the compound (A), 4HBA as the monomer (B) with a free radical polymerizable double bond, TPO as the photo-polymerization initiator (C), bis[4-(allylbicyclo[2.2.1]hept-5-ene-2,3-dicarboximido)phenyl]methane (hereinafter, referred to as BANIM) as the alkenyl substituted nadi-imide compound, and phenothiazine as the polymerization inhibitor were mixed and dissolved, and then filtered by a membrane filter (1 μm) made of fluorocarbon resin, to prepare an ink-jet ink 5.

| | |
|---|---|
| Ripoxy HFA-6127 | 50.00 g |
| 4HBA | 100.00 g |
| TPO | 10.00 g |
| BANIM | 20.00 g |
| Phenothiazine | 0.04 g |

The ink-jet ink 5 was processed through the same way as that in Example 1, to get a Kapton substrate 5 with a cured film having a thickness of 27 μm formed thereon. The jetting temperature was 70° C. Then, the Kapton substrate 5, taking the surface with the cured film formed thereon as an external surface, was wound for 100 times to form a cylinder having a radius of 1 mm, and then was observed with a microscope. Finally, it was found that the patterns had no cracks.

### INDUSTRIAL APPLICATION

The cured film formed by using the ink-jet ink of the invention has excellent softness, which thus can be used as, for example, protective film, or insulating film in electronic circuit boards.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An ink-jet ink, comprising larger than or equal to 10 wt % of a compound (A) with a structure of formula (1): 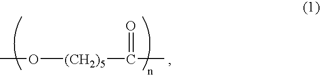
in formula (1), n is an integer of 1-10.

2. The ink-jet ink according to claim 1, wherein the compound (A) with the structure of formula (1) has a free radical polymerizable double bond.

3. The ink-jet ink according to claim 2, wherein the compound (A) has three or more structures of formula (1).

4. The ink-jet ink according to claim 2, wherein the compound (A) with the structure of formula (1) is a compound of formula (2), (3), (4), or (5): 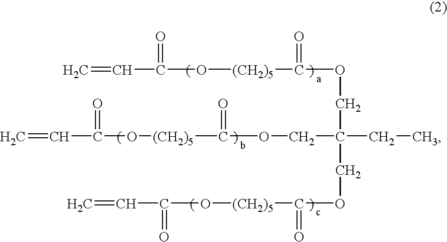
in formula (2), a, b, and c are independently integers of 0-10, and a+b+c≧1; 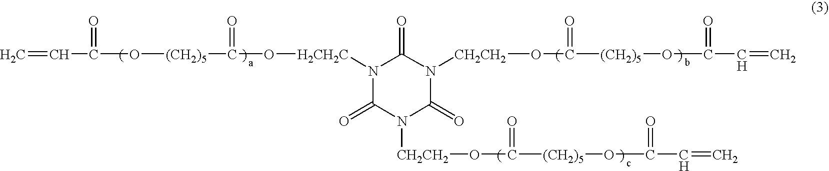
in formula (3), a, b, and c are independently integers of 0-10, and a+b+c≧1. 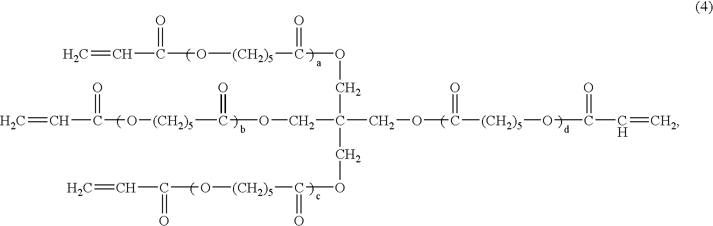
in formula (4), a, b, c, and d are independently integers of 0-10, and a b+c+d≧1 and 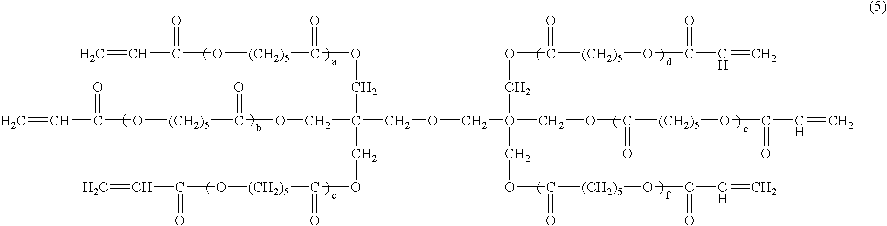
in formula (5), a, b, c, d, e, and f are independently integers of 0-10, and a+b+c+d+e+f≧1.

5. The ink-jet ink according to claim 1, wherein the compound (A) with the structure of formula (1) contains phosphorus.

6. The ink-jet ink according to claim 5, wherein the compound (A) with the structure of formula (1) is a compound of formula (6), (7), (8), or (9): 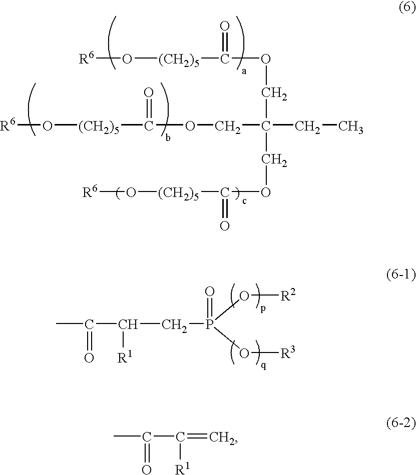
in formula (6), a, b, and c are independently integers of 0-10, a+b+c≧1, R⁶ has r groups of formula (6-1), and s groups of formula (6-2), r is an integer of 1-3, s is an integer of 0-2, (r+s) equals to 3, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ are integrated to form a cyclic group, p and q are independently 0 or 1; 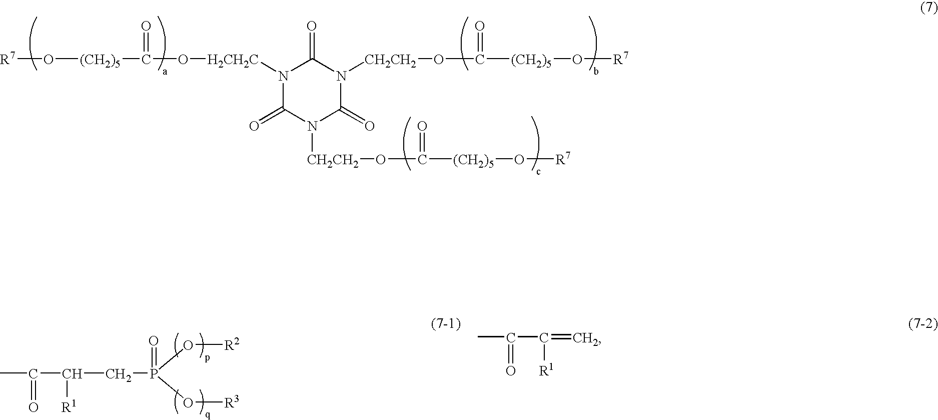
in formula (7), a, b, and c are independently integers of 0-10, a+b+c≧1, R⁷ has r groups of formula (7-1), and s groups of formula (7-2), r is an integer of 1-3, s is an integer of 0-2, (r+s) equals to 3, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ are integrated to form a cyclic group, p and q are independently 0 or 1; 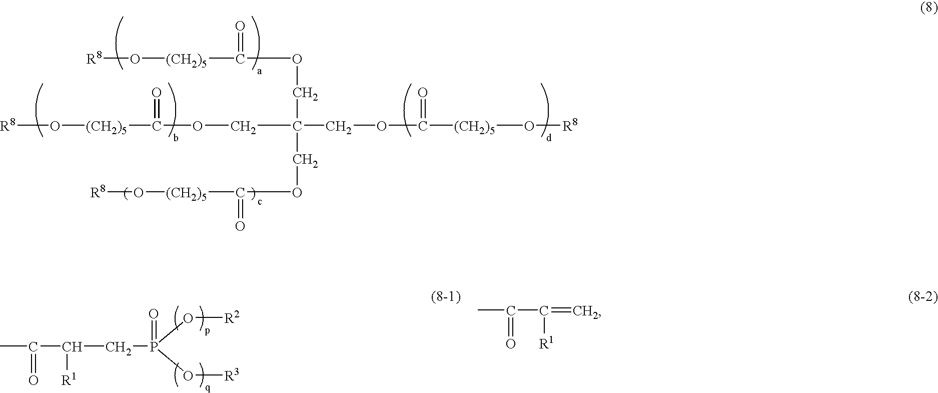
in formula (8), a, b, c, and d are independently integers of 0-10, a+b+c+d≧1, R⁸ has r groups of formula (8-1), s groups of formula (8-2), r is an integer of 1-4, and s is an integer of 0-3, (r+s) equals to 4, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ are integrated to form a cyclic group, p and q are independently 0 or 1; and 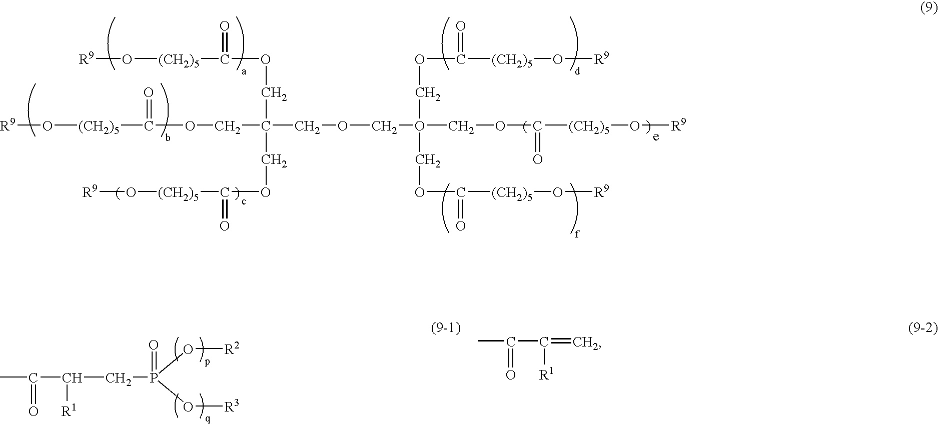
in formula (9), a, b, c, d, e, and f are independently integers of 0-10, a+b+c+d+e+f≧1, R⁹ has r groups of formula (9-1), s groups of formula (9-2), r is an integer of 1-6, and s is an integer of 0-5, (r+s) equals to 6, R¹ is hydrogen or methyl, R² and R³ are independently alkyl having 1-20 carbon atoms, phenyl, phenyl with any hydrogen substituted by alkyl having 1-5 carbon atoms, or phenyl with any hydrogen substituted by phenyl, R² and R³ are integrated to form a cyclic group, p and q are independently 0 or 1.

7. The ink-jet ink according to claim 6, wherein the group of formula (6-1), (7-1), (8-1), or (9-1) in formula (6), (7), (8), or (9) is the group of formula (10): 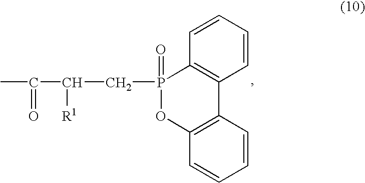
in formula (10), R¹ is hydrogen or methyl.

8. The ink-jet ink according to claim 1, further comprising a monomer (B) with a free radical polymerizable double bond.

9. The ink-jet ink according to claim 8, wherein the monomer (B) with a free radical polymerizable double bond also has a thermosetting functional group.

10. The ink-jet ink according to claim 9, wherein the thermosetting functional group is one or more selected from the group consisting of hydroxyl, carboxyl, amino, alkoxyl, oxirane, and oxetane.

11. The ink-jet ink according to claim 8, wherein the monomer (B) with a free radical polymerizable double bond is a compound of formula (11) or a compound of formula (12): 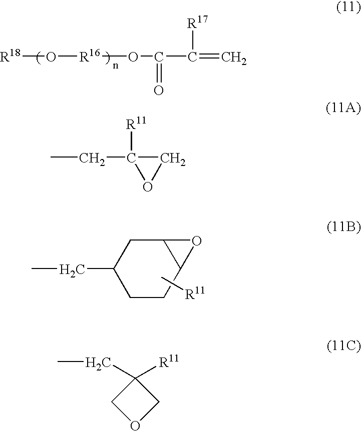
in formula (11), each R¹⁶ is independently alkylene having 2-12 carbon atoms that may have a cyclic structure, R¹⁷ is alkyl having 1-3 carbon atoms or hydrogen, n is an integer of 0-30, R¹⁸ is hydrogen or any of the groups of formulas (11A)-(11C), and in formulas (11A)-(11C), each R¹¹ is independently hydrogen or alkyl having 1-5 carbon atoms respectively; 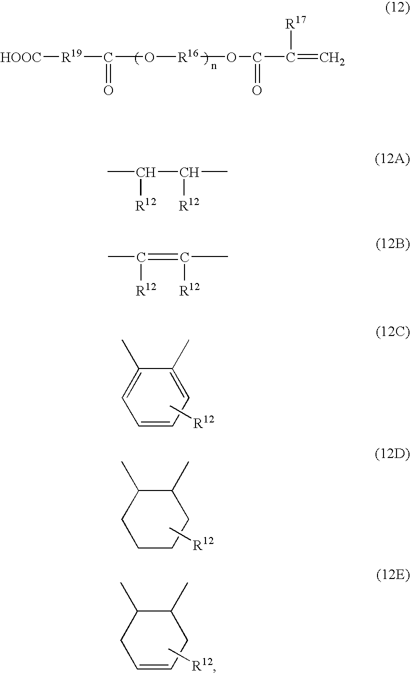
in formula (12), each R¹⁶ is independently alkylene having 2-12 carbon atoms that may have a cyclic structure, R¹⁷ is alkyl having 1-3 carbon atoms or hydrogen, n is an integer of 0-30, R¹⁹ is any one of the groups of formulas (12A)-(12E), and in formula (12A)-(12E), each R¹² is independently hydrogen or alkyl having 1-5 carbon atoms respectively.

12. The ink-jet ink according to claim 11, wherein in formula (11), R¹⁶ is ethylene, propylene, butylene, or a group of formula (B), R¹⁷ is hydrogen or methyl, n is an integer of 1-5, and R¹⁸ is hydrogen,
in formula (12), R¹⁶ is ethylene, propylene, butylene, or a group of formula (B), R¹⁷ is hydrogen or methyl, n is an integer of 1-5, R¹⁹ is any one of the groups of formulas (12A)-(12E), in formulas (12A)-(12E), each R¹² is independently hydrogen or methyl,

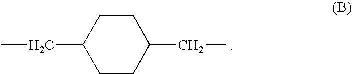

13. The ink-jet ink according to claim 8, comprising a monomer (B) with a free radical polymerizable double bond, wherein the monomer (B) with a free radical polymerizable double bond is one or more polymerizable monomers selected from the group consisting of 2-hydroxyethyl(meth)acrylate, 2-hydroxypropyl(meth)acrylate, 4-hydroxybutyl(meth)acrylate, cyclohexanedimethanol mono(meth)acrylate, 2-(meth)acryloxy ethylsuccinic acid, 2-(meth)acryloxy ethylmaleic acid, 2-(meth)acryloxy ethylphthalic acid, 2-(meth)acryloxy ethylhexahydrophthalic acid, and 2-(meth)acryloxy ethyltetrahydrophthalic acid.

14. The ink-jet ink according to claim 1, further comprising dual-functional (meth)acrylate.

15. The ink-jet ink according to claim 14, wherein the dual-functional (meth)acrylate is one or more selected from the group consisting of bisphenol F oxirane modified di(meth)acrylate, bisphenol A oxirane modified di(meth)acrylate, oxirane isocyanurate modified di(meth)acrylate, 1,4-butanediol di(meth)acrylate, 1,6-hexanediol di(meth)acrylate, and 2,2-dimethyl-1,3-propandioldi(meth)acrylate.

16. The ink-jet ink according to claim 1, further comprising an alkenyl substituted nadi-imide compound.

17. The ink-jet ink according to claim 16, wherein the alkenyl substituted nadi-imide compound is a compound of formula (20): 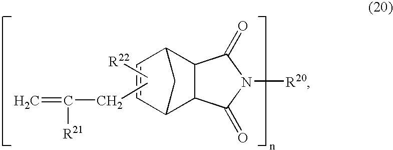
in formula (20), R²¹ and R²² are dependently hydrogen, alkyl having 1-12 carbon atoms, alkenyl having 3-6 carbon atoms, cycloalkyl having 5-8 carbon atoms, aryl having 6-12 carbon atoms or benzyl, R²⁰ is an organic group having 1-300 carbon atoms, and n is an integer of 1-4.

18. The ink-jet ink according to claim 16, wherein the alkenyl substituted nadi-imide compound is a compound of formula (21): 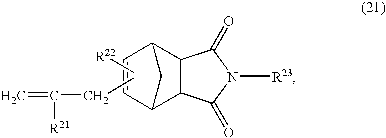
in formula (21), R²¹ and R²² are independently hydrogen, alkyl having 1-12 carbon atoms, alkenyl having 3-6 carbon atoms, cycloalkyl having 5-8 carbon atoms, aryl having 6-12 carbon atoms or benzyl, R²³ is hydrogen, alkyl having 1-12 carbon atoms, hydroxyalkyl having 1-12 carbon atoms, cycloalkyl having 5-8 carbon atoms, aryl having 6-12 carbon atoms, benzyl, a group of —{(CH₂)_{q}Oₜ(CH₂)ᵣOᵤ(CH₂)ₛX} (wherein q, r, and s are independently integers of 2-6 respectively, t is an integer of 0 or 1, u is an integer of 1-30, X is hydrogen or —OH), a group of —(R)ₐ—C₆H₄—R⁴ (wherein a is an integer of 0 or 1, R is alkylene having 1-4 carbon atoms, and R⁴ is hydrogen or alkyl having 1-4 carbon atoms), a group of formula (A): 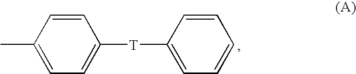
(wherein, T is —CH₂—, —C(CH₃)₂—, —CO—, —S—, or —SO₂—), or the above groups with 1-3 hydrogens directly bonded to an aromatic ring being substituted by —OH.

19. The ink-jet ink according to claim 16, wherein the alkenyl substituted nadi-imide compound is a compound of formula (22): 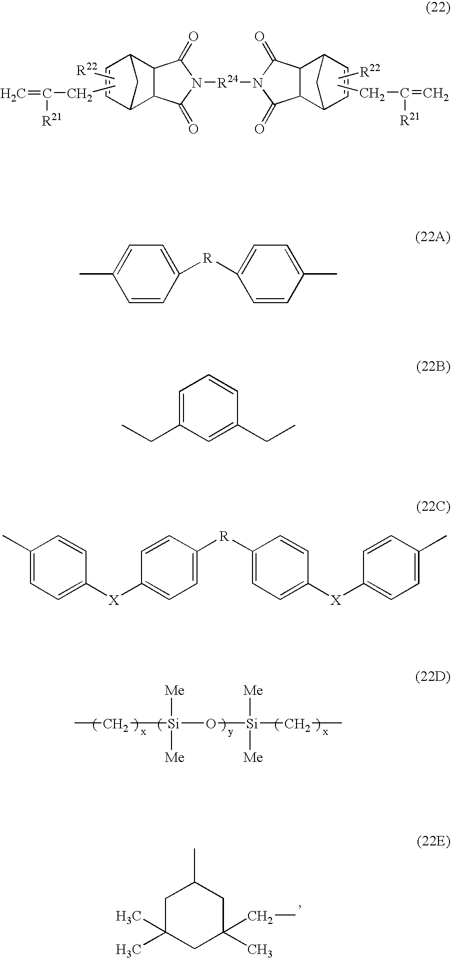
in formula (22), R²¹ and R²² are dependently hydrogen or alkyl having 1-6 carbon atoms respectively;
R²⁴ is alkylene having 2-15 carbon atoms (wherein any methylene not adjacent to each other in the alkylene is unsubstituted or substituted by —O— or —CH—CH—, and any hydrogen is unsubstituted or substituted by fluorine), a group of formula (22A), a group of formula (22B), a group of formula (22C), a group of formula (22D), and a group of formula (22E);
in formulas (22A) and (22C), R is —CH₂—, —CH₂CH₂—, —O—, —C(CH₃)₂—, —C(CF₃)₂—, or —SO₂—, in formula (22C), X is independently —CH₂— or —O— respectively, in formula (22D), x is independently an integer of 1-6 respectively, and y is an integer of 1-70.

20. The ink-jet ink according to claim 16, wherein the alkenyl substituted nadi-imide compound is a compound of formula (23): 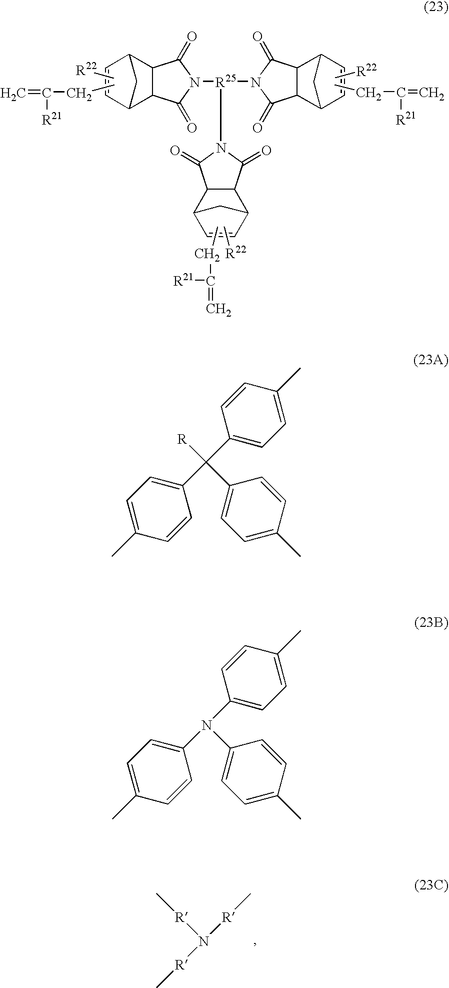
in formula (23), R²¹ and R²² are dependently hydrogen or alkyl having 1-6 carbon atoms respectively, R²⁵ is a group of formula (23A), a group of formula (23B), or a group of formula (23C); and
in formula (23A), R is alkyl having 1-10 carbon atoms or —OH, in formula (23C), each R′ is independently 1,2-ethylene or 1,4-butylene.

21. The ink-jet ink according to claim 16, wherein the alkenyl substituted nadi-imide compound is a compound of formula (24): 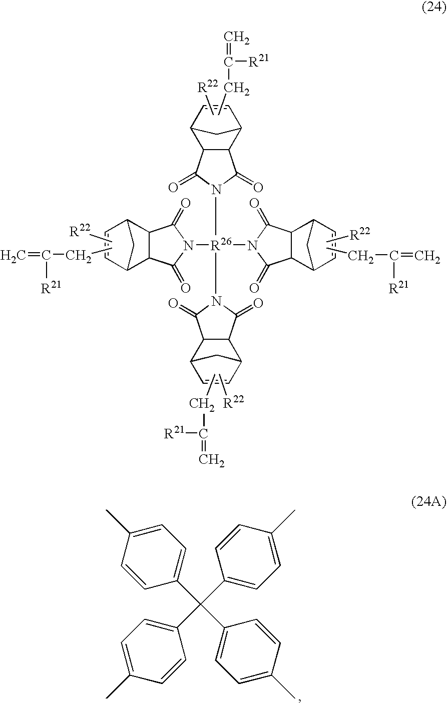
in formula (24), R²¹ and R²² are dependently hydrogen or alkyl having 1-6 carbon atoms respectively, and R²⁶ is a group of formula (24A).

22. The ink-jet ink according to claim 16, wherein the alkenyl substituted nadi-imide compound is a compound obtained by a reaction of monoamine, diamine, triamine, or teteramine with a compound of formula (25): 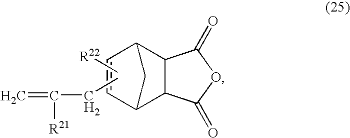
in formula (25), R²¹ and R²² are independently any one of hydrogen, alkyl having 1-12 carbon atoms, alkenyl having 3-6 carbon atoms, cycloalkyl having 5-8 carbon atoms, aryl having 6-12 carbon atoms or benzyl respectively.

23. The ink-jet ink according to claim 1, further comprising at least one bismaleimide compound.

24. The ink-jet ink according to claim 23, wherein the bismaleimide compound is a compound of formula (30): 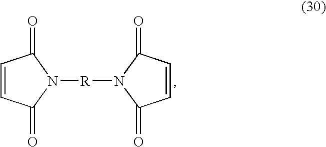
in formula (30), R is a bivalent organic group having 2-30 carbon atoms.

25. The ink-jet ink according to claim 24, wherein R in formula (30) is selected from the group consisting of the following groups:

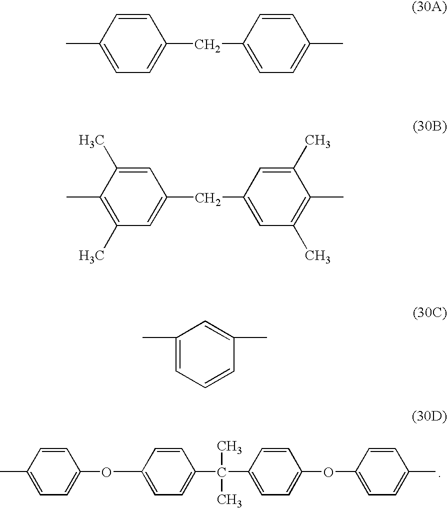

26. The ink-jet ink according to claim 1, further comprising a photo-polymerization initiator (C).

27. The ink-jet ink according to claim 26, wherein the photo-polymerization initiator (C) is bis(2,4,6-trimethylbenzoyl)phenyl phosphine oxide or 2,4,6-trimethylbenzoyl diphenyl phosphine oxide.

28. The ink-jet ink according to claim 26, wherein the compound (A) with the structure of formula (1) is selected from one of the compounds of formula (6) formula (9) and a mixture thereof, monomer (B) with a free radical polymerizable double bond is selected from one of 4-hydroxybutyl(meth)acrylate, 1,4-cyclohexanedimethanol mono(meth)acrylate and a mixture thereof, and the photo-polymerization initiator (C) is selected from one of bis(2,4,6-trimethylbenzoyl)phenyl phosphine oxide, 2,4,6-trimethylbenzoyl diphenyl phosphine oxide and a mixture thereof.

29. The ink-jet ink according to claim 1, wherein the ink-jet ink is free of a solvent with a boiling point lower than or equal to 300° C. at a normal pressure, or a content of the solvent with the boiling point lower than or equal to 300° C. at the normal pressure is less than or equal to 10 wt %.

30. An electronic circuit board, with a cured film formed thereon by using the ink-jet ink according to claim 1.

31. An electronic component, provided with the electronic circuit board according to claim 30.

32. A display device, provided with the electronic component according to claim 31.
